(19) United States
(12) Patent Application Publication
(10) Pub. No.: US 2022/0196145 A1
(43) Pub. Date: Jun. 23, 2022

(54) VALVE AND SPRING RETENTION FOR ADDITIVE MANUFACTURED VALVE BODY

(71) Applicant: John N. Henley, III, Auburn Hills, MI (US)

(72) Inventor: John N. Henley, III, Auburn Hills, MI (US)

(21) Appl. No.: 17/131,969

(22) Filed: Dec. 23, 2020

(51) Int. Cl. F16H 61/02; B33Y 80/00; F16H 61/00

(52) U.S. Cl. CPC F16H 61/0276; F16H 2061/0279; F16H 61/0009; B33Y 80/00

(57) ABSTRACT

An additive manufactured (AM) hydraulic control assembly includes an AM housing having a tubular wall defining a bore configured to receive at least one of a hydraulic valve and an accumulator, and a retainer clip configured to selectively secure to the AM housing such that the retainer clip is movable between a secured position that extends across at least a portion of the bore to retain the hydraulic valve or accumulator within the AM housing, and an unsecured position that enables the hydraulic valve or accumulator to be inserted into or removed from the bore.

### FIELD

The present application relates generally to transmission hydraulic control units and, more particularly, to systems for retaining valves and springs in an additive manufactured valve body for a hydraulic control unit.

### BACKGROUND

Modern vehicle transmissions typically include a hydraulic control unit to control hydraulic pressure and direct hydraulic fluid within hydraulic passages to control one or more components of the transmission. Some typical configurations include multiple layers of cast bodies divided by separator plates and all clamped together with many fasteners. This can potentially lead to leakage at the interface between the valve body and separator plates. Due to the nature of the casting process by which these parts are made, the minimum size of the hydraulic passages is typically in excess of the requirement, thereby potentially adding unnecessary mass to the system. Thus, while such conventional systems work well for their intended purpose, there remains a desire for improvement in the relevant art.

### SUMMARY

According to one example aspect of the invention, an additive manufactured (AM) hydraulic control assembly is provided. In one example configuration, the assembly includes an AM housing having a tubular wall defining a bore configured to receive at least one of a hydraulic valve and an accumulator, and a retainer clip configured to selectively secure to the AM housing such that the retainer clip is movable between a secured position that extends across at least a portion of the bore to retain the hydraulic valve or accumulator within the AM housing, and an unsecured position that enables the hydraulic valve or accumulator to be inserted into or removed from the bore.

In addition to the foregoing, the described assembly may include one or more of the following features: an AM hydraulic passage having a second tubular wall defining a fluid passage, wherein the AM hydraulic passage is fluidly coupled to the bore; wherein the at least one of a hydraulic valve and an accumulator comprises an accumulator having a plunger and a biasing mechanism; wherein the AM housing includes a slot formed through the tubular wall, and wherein the retainer clip includes an intermediate arm configured to be received within the slot when in the secured position; and wherein the intermediate arm is coupled to a main body between a pair of opposed arms configured to clip to the AM housing.

In addition to the foregoing, the described assembly may include one or more of the following features: wherein the retainer clip is an AM retainer clip formed with the AM housing; wherein the retainer clip includes a retainer body disposed between an attaching end configured to attach the retainer clip to the AM housing, and a securing end configured to selectively secure the retainer clip to the AM housing when in the secured position; wherein the attaching end is hingedly coupled to the AM valve housing, and the securing end includes a detent configured to engage a projection formed on the AM valve housing when in the secured position; wherein the attaching end includes a pair of knuckles additively manufactured with a clearance between the pair of knuckles and a pin formed on the AM housing; and wherein the attaching end includes a pin with opposed ends having detents formed therein, the detents configured to receive opposed projections extending from opposed support members integrally formed with the AM housing.

In addition to the foregoing, the described assembly may include one or more of the following features: wherein the tubular wall includes an end face with at least one recess formed therein, and wherein when in the secured position, the retainer clip is constrained within the recess from transverse movement to facilitate preventing detachment of the securing end from the AM housing; wherein the at least one of a hydraulic valve and an accumulator comprises a hydraulic valve having a biasing mechanism and a seal coupled to a valve stem; and wherein the securing end is hook-shaped and configured to receive a tab integrally formed with and extending outwardly from the AM housing tubular wall; and wherein the securing end includes a transverse member defining opposed tabs configured to engage a pair of outer tabs integrally formed with and extending outwardly from the AM housing tubular wall.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present application, its application or uses. Thus, variations that do not depart from the gist of the present application are intended to be within the scope of the present application.

### BRIEF DESCRIPTION OF THE DRAWINGS

FIG. 1 is a bottom perspective view of an example additive manufactured (AM) valve body for a vehicle transmission, in accordance with the principles of the present application;

FIG. 2 is a top perspective view of the AM valve body shown in FIG. 1, in accordance with the principles of the present application;

FIG. 3 is a side view of an example AM accumulator housing that may be formed in the AM valve body shown in FIG. 1, in accordance with the principles of the present application;

FIG. 4 is a top sectional view of an example retainer clip coupled to the AM accumulator housing shown in FIG. 3, in accordance with the principles of the present application;

FIG. 5 is a cross-sectional view of the retainer clip and AM accumulator housing shown in FIGS. 3 and 4, in accordance with the principles of the present application;

FIG. 6 is a perspective view of an example AM retainer clip and AM valve housing that may be formed in the AM valve body shown in FIG. 1, in accordance with the principles of the present application;

FIG. 7 is a cross-sectional view of the AM valve housing and retainer clip shown in FIG. 6, in accordance with the principles of the present application;

FIG. 8 is a perspective view of another example retainer clip and AM valve housing that may be formed in the AM valve body shown in FIG. 1, in accordance with the principles of the present application;

FIG. 9 is a cross-sectional view of the AM valve housing and retainer clip shown in FIG. 8, in accordance with the principles of the present application;

FIG. 10 is another cross-sectional view of the AM valve housing and retainer clip shown in FIG. 8 and taken along line 10-10, in accordance with the principles of the present application;

FIG. 11 is a cross-sectional view of another example retainer clip and AM valve housing that may be formed in the AM valve body shown in FIG. 1, in accordance with the principles of the present application;

FIG. 12 is a side end view of the AM valve housing and retainer clip shown in FIG. 11, in accordance with the principles of the present application;

FIG. 13 is a perspective view of another example retainer clip and AM valve housing that may be formed in the AM valve body shown in FIG. 1, in accordance with the principles of the present application;

FIG. 14 is a cross-sectional view of the AM valve housing and retainer clip shown in FIG. 13, in accordance with the principles of the present application; and

FIG. 15 is a side end view of the AM valve housing and retainer clip shown in FIG. 13, in accordance with the principles of the present application.

### DESCRIPTION

The present application is directed to a transmission hydraulic control unit having one or more additive manufactured (AM) features such as, for example, hydraulic valve housings, accumulator housings, and retainer clips therefor. The AM hydraulic valve housing includes a bore configured to receive a hydraulic valve, and the retainer clip is coupled to the valve housing to retain the hydraulic valve in the bore. Similarly, the AM accumulator housing includes a bore configured to receive an accumulator, and the retainer clip is coupled to the accumulator housing to retain the accumulator in the bore. In some examples, the retainer clip is formed during the additive manufacturing process of the valve housing or accumulator housing.

In one example, a slot is formed through the housing wall perpendicular to the axis of the bore. A middle leg of a three-legged retaining clip is then inserted into the slot. The two outside legs of the clip are formed to snap over the round exterior wall of the housing to thereby secure the retainer clip to the housing. The force of the valve and spring forces the retainer clip against the end of the slot.

In another example, using additive manufacturing processes, a retainer clip is permanently attached to the end of the housing. A hinge connects the end of the bore and the edge of the retaining clip. A clearance is formed between the AM retaining clip and hinge such that the retaining clip moves freely and is permanently assembled thereto. The retainer clip can rotate about the hinge to enable insertion or removal of the valve or accumulator. The retainer clip includes a ramp or detent that snaps over a raised portion of the housing such that the retainer is latched in place to facilitate preventing the force of the hydraulic control valve and spring from unlatching it.

In yet another example, the retainer clip is formed with a hook-type feature at one end and a detent with a latching feature at the other end. A tab formed on the AM housing receives the hook, and a raised surface projection on the AM housing receives the latching feature and is inverse thereto. The raised surface allows the retainer to slide over the surface and latch into place. Edges of the housing extend beyond the clip to prevent the clip from slipping off.

In another example, the retainer clip is T-shaped and includes a ramp with a latching feature. The retainer clip is secured between a pair of projections formed on the AM housing. The projections extend away from the bore face to enable the retainer to be positioned vertically with one face mated to the bore face and the other mated to the projections such that the retainer is constrained along the axis of the bore. A raised surface formed on the AM housing is the inverse of a distal portion of the retainer clip and allows the retainer to slide over the raised surface and latch into place thereon to facilitate preventing valve/spring forces from unlatching.

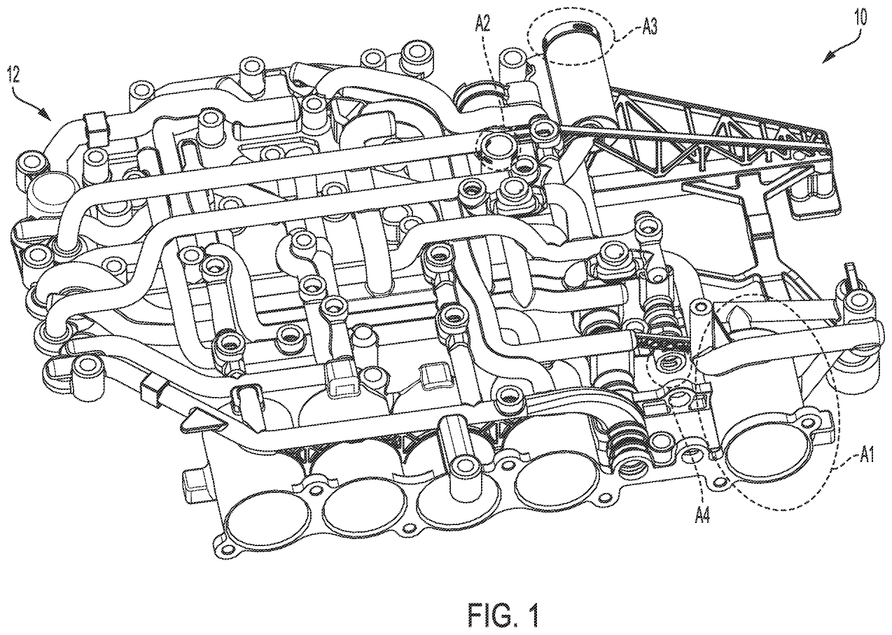

Referring now to the drawings, FIG. 1 illustrates an example hydraulic control assembly or unit 10 configured to be disposed within a transmission of a vehicle (not shown). The hydraulic control unit 10 generally includes a valve body 12. In the example embodiment, at least a portion of the valve body 12 is fabricated from an additive manufacturing (AM) process such as, for example, binder jetting, directed energy deposition, material jetting, material extrusion, sheet lamination, and vat polymerization. The additive manufacturing process enables hydraulic control unit 10 to have a valve body 12 formed with unique integrated features including valve housings, accumulator housings, and retainer members therefor, as described herein in more detail. Further, although described in connection with a transmission hydraulic control unit, it will be appreciated that the AM features described herein may be utilized for other fluid or hydraulic control systems.

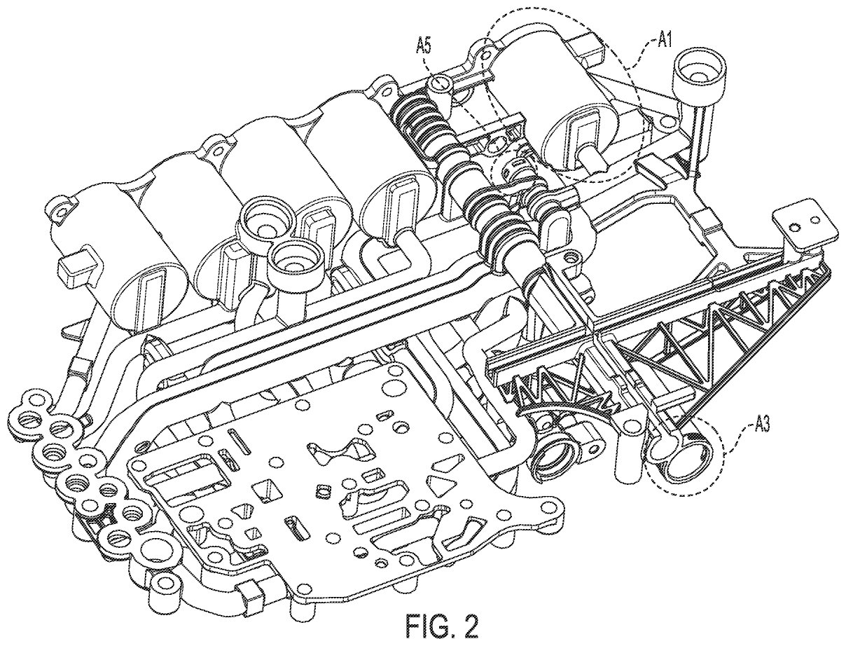

With reference to FIGS. 2 and 3-5, the valve body 12 includes a section ‘A1’ At illustrating an AM hydraulic passage 100 integrated with an AM accumulator housing 102. In the example embodiment, the AM hydraulic passage 100 includes a tubular wall 104 defining a fluid passage 106, and the AM accumulator housing 102 includes a tubular wall 108 defining a bore 110, which is fluidly coupled to the fluid passage 106 via a hydraulic orifice 112. As shown in FIG. 5, the bore 110 is configured to receive an accumulator assembly 114, which includes a plunger 116 and a biasing mechanism 118 (e.g., a spring). The plunger 116 seals against the inner surface of the tubular wall 108 (e.g., via seals, small clearance, etc.) and is configured to slide within the bore 110. The biasing mechanism 118 is seated within the plunger 116 and configured to bias the plunger 116 toward the hydraulic orifice 112.

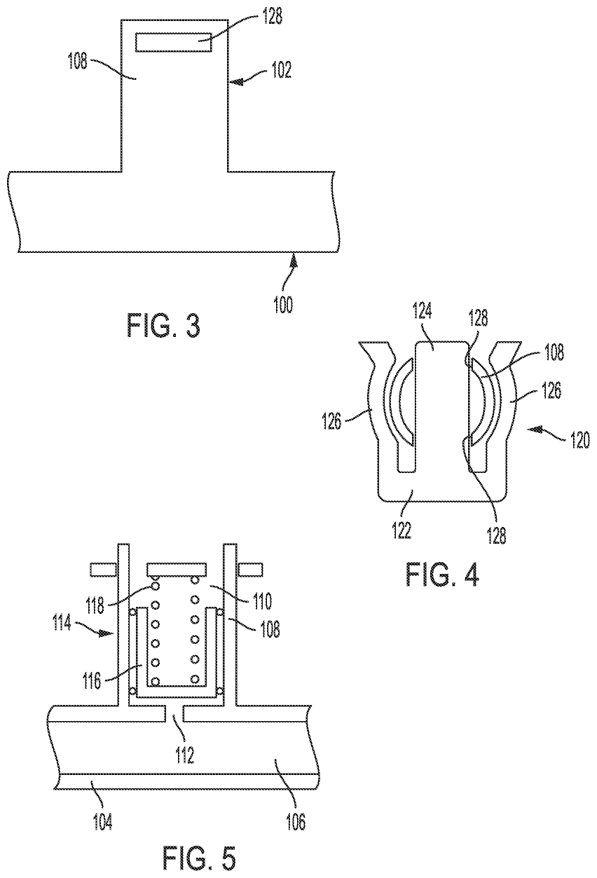

As shown in FIGS. 4 and 5, in the example embodiment, accumulator assembly 114 is retained within housing bore 110 by a retainer mechanism or clip 120. The retainer clip 120 includes a main body 122 having an intermediate arm 124 disposed between a pair of opposed arms 126. In some implementations, the retainer clip 120 is also fabricated from an additive manufacturing process. The intermediate arm 124 is configured to be inserted into a slot 128 (FIGS. 3, 4) formed in the AM accumulator housing 102, and the pair of opposed arms 126 are configured to extend around and grasp the AM accumulator housing 102 to thereby secure the retainer clip 120 to the AM accumulator housing 102. Once assembled, the plunger 116 and biasing mechanism 118 are retained within the AM accumulator housing 102 against hydraulic forces acting against the plunger 116. Additionally, retainer clip 120 may be utilized in other areas of valve body 12 such as, for example, sections ‘A2’-'A5′ shown in FIGS. 1 and 2.

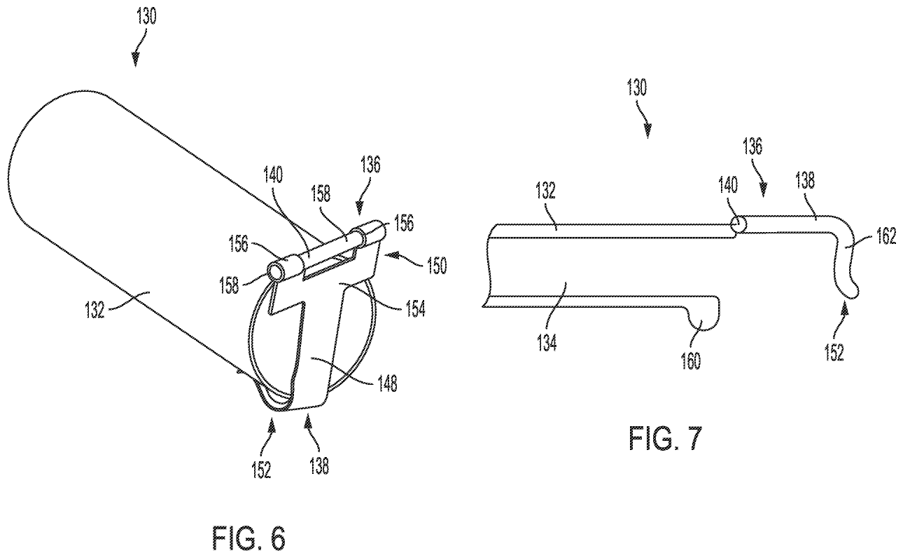

With reference to FIGS. 6 and 7, an alternative retaining arrangement includes an AM valve housing 130 having a tubular wall 132 defining a bore 134 configured to receive a hydraulic valve assembly (not shown). In the example embodiment, the AM valve housing 130 is integrally formed with an AM retainer assembly 136, which includes a retainer mechanism or clip 138 hingedly coupled to a pin 140.

In the example embodiment, the retainer clip 138 generally includes a retainer body 148 disposed between an attaching end 150 and a securing end 152. The attaching end 150 includes a support member 154 having a pair of knuckles 156 each defining an aperture 158 for receiving the pin 140. During the additive manufacturing process, the attaching end 150 is formed with a clearance between the knuckles 156 and the pin 140, thereby providing a hinged coupling between the retainer clip 138 and the pin 140. As shown in FIG. 7, an outer surface of the tubular wall 132 is formed with a raised projection 160. The retainer clip securing end 152 includes a detent 162 sized and shaped to interferingly engage the projection 160 when the retainer clip 138 is moved to a closed position (FIG. 6), such that retainer body 148 extends across the opening of valve bore 134 and facilitates retaining the hydraulic valve assembly within the valve bore 134. When desired, the retainer clip 138 is rotated to an open position (e.g., FIG. 7) to enable removal or insertion of the hydraulic valve assembly.

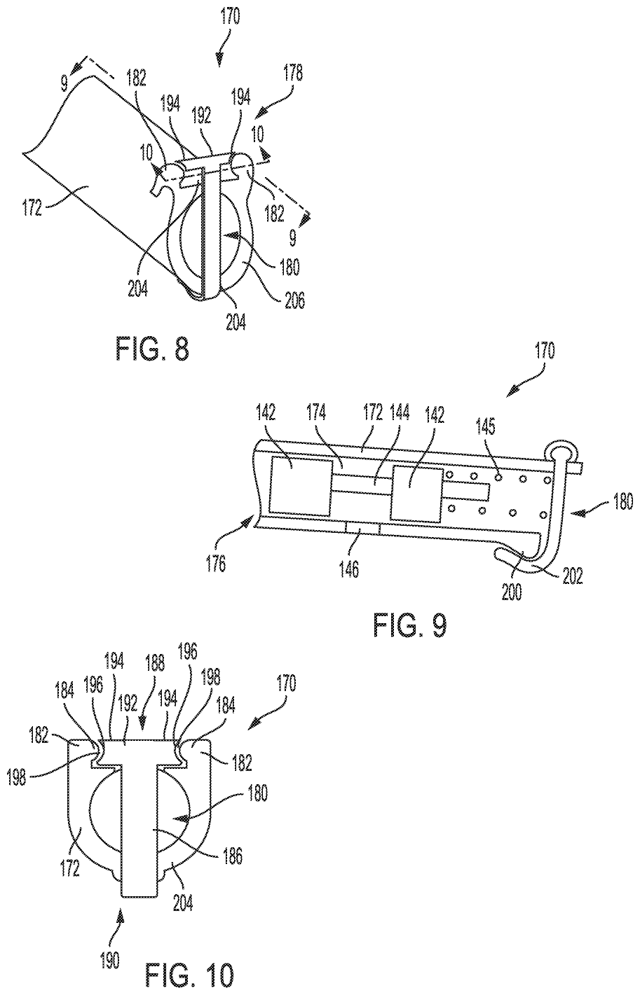

With reference now to FIGS. 8-10, yet another alternative retaining arrangement includes an AM valve housing 170 having a tubular wall 172 defining a bore 174 configured to receive a hydraulic valve assembly 176 (FIG. 9). In the example embodiment, the hydraulic valve assembly 176 includes valves 142 on a valve stem 144 biased by a biasing mechanism 145 and selectively translatable by hydraulic signal pressure, manual shift cable, solenoid assembly, etc. (not shown) within the bore 174 to selectively seal one or more hydraulic ports 146.

In the example embodiment, the AM valve housing 170 is integrally formed with an AM retainer assembly 178, which includes a retainer mechanism or clip 180 hingedly coupled between a pair of support members 182. As shown in FIG. 10, each support member 182 is integrally formed with the tubular wall 172 and includes a rounded projection 184 extending inwardly toward the other.

In the example embodiment, the retainer clip 180 generally includes a retainer body 186 disposed between an attaching end 188 and a securing end 190. The attaching end 188 includes a pin 192 having opposed ends 194 with detents 196. As shown in FIG. 10, the detents 196 are sized and shaped to receive the rounded projections 184 to thereby provide a hinged coupling between the retainer clip 180 and the pair of support members 182. In some implementations, the retainer clip 180 is also fabricated during the additive manufacturing process. In such an example, the retainer clip 180 is formed with a small clearance 198 between the detents 196 and rounded projections 184 to enable relative movement therebetween.

As shown in FIG. 9, an outer surface of the tubular wall 172 is formed with a raised projection 200. The retainer clip securing end 190 includes a detent 202 sized and shaped to interferingly engage the projection 200 when the retainer clip 180 is moved to a closed position (FIGS. 8-10), such that retainer body 186 extends across the opening of valve bore 174 and facilitates retaining the hydraulic valve assembly 176 within the valve bore 174. In this position, as shown in FIG. 8, the retainer clip 180 is seated within recesses 204 formed in an end surface 206 of the AM valve housing 170. As such, in the closed position, the retainer clip 180 sits flush with or substantially flush with the end surface 206 and is constrained from transverse movement. When desired, the retainer clip 180 is rotated to an open position (not shown) to enable removal or insertion of the hydraulic valve assembly 176.

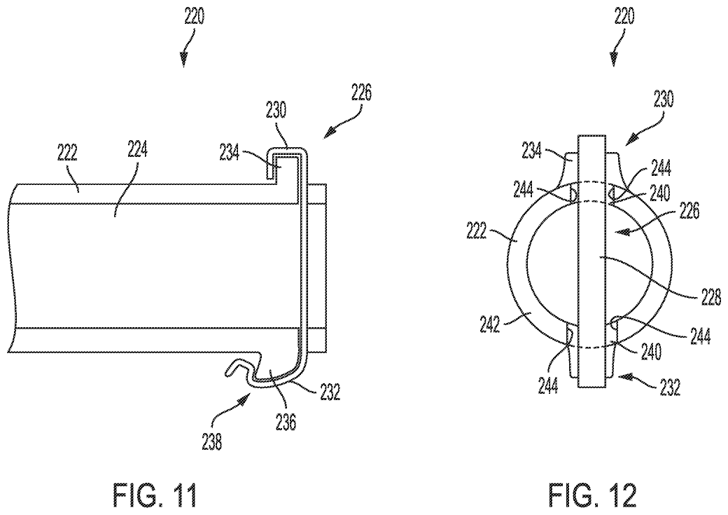

With reference now to FIGS. 11 and 12, another alternative retaining arrangement includes an AM valve housing 220 having a tubular wall 222 defining a bore 224 configured to receive a hydraulic valve assembly (not shown). In the example embodiment, the hydraulic valve assembly is retained within housing bore 224 by a retainer mechanism or clip 226, which generally includes a retainer body 228 disposed between an attaching end 230 and a securing end 232. In some implementations, the retainer clip 226 is also fabricated during the additive manufacturing process.

In the example embodiment, the attaching end 230 is generally hook-shaped and is configured to receive a tab 234 extending outwardly from an outer surface of the tubular wall 222, as shown in FIG. 11. As illustrated, the outer surface of the tubular wall 222 is also formed with a raised projection 236. The retainer clip securing end 232 includes a detent 238 sized and shaped to interferingly engage the projection 236 when the retainer clip 226 is moved to a closed position (FIGS. 11 and 12), such that retainer body 228 extends across the opening of valve bore 224 and facilitates retaining the hydraulic valve assembly within the valve bore 224. In this position, as shown in FIG. 12, the retainer clip 226 is seated within recesses 240 formed in an end surface 242 of the AM valve housing 220. As such, side walls 244 of the recesses 204 facilitate preventing transverse movement of the retainer clip 226 and thus unwanted uncoupling of the retainer clip 226 from the AM valve housing 220. When desired, the retainer clip 226 is detached from the projection 236 and subsequently tab 234 to enable removal or insertion of the hydraulic valve assembly.

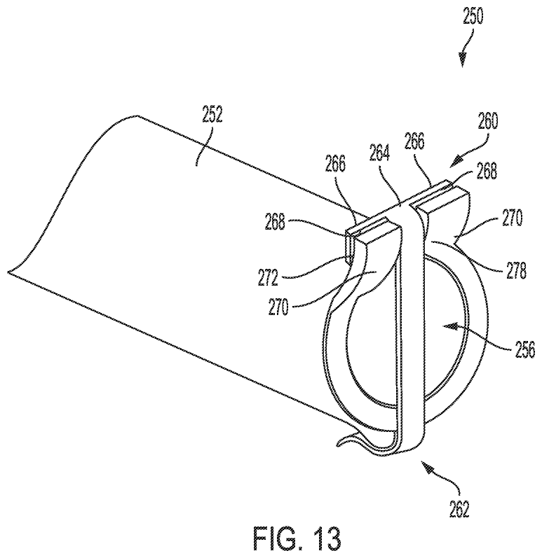

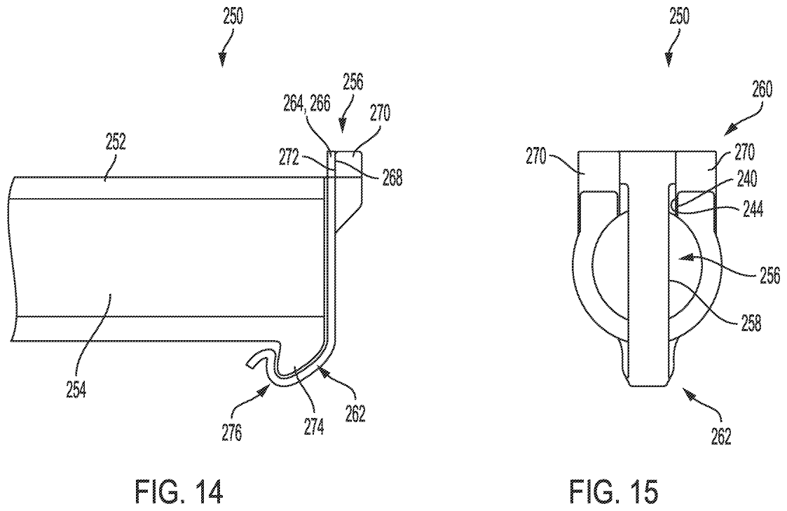

With reference now to FIGS. 13-15, another alternative retaining arrangement includes an AM valve housing 250 having a tubular wall 252 defining a bore 254 configured to receive a hydraulic valve assembly (not shown). In the example embodiment, the hydraulic valve assembly is retained within housing bore 254 by a retainer mechanism or clip 256, which generally includes a retainer body 258 disposed between an attaching end 260 and a securing end 262. In some implementations, the retainer clip 256 is also fabricated during the additive manufacturing process.

In the example embodiment, the attaching end 260 is a generally transverse member or bar 264 defining opposed tabs 266 with an inner surface 268. As shown in FIG. 13, the AM valve housing 250 is formed with a pair of outer tabs 270 extending outwardly from an outer surface of the tubular wall 252. The retainer clip 256 is configured to be located with the retainer body 258 disposed between the outer tabs 270 such that tab inner surfaces 268 abut against an outer surface 272 of the outer tabs 270.

Further, in the example embodiment, the outer surface of the tubular wall 222 is also formed with a raised projection 274. The retainer clip securing end 262 includes a detent 276 sized and shaped to interferingly engage the projection 274 when the retainer clip 256 is moved to a closed position (FIGS.13-16), such that retainer body 258 extends across the opening of valve bore 254 and facilitates retaining the hydraulic valve assembly within the valve bore 254.

Additionally, in this position, as shown in FIG. 13, the retainer clip 256 is disposed between side walls 278 of the outer tabs 270 to facilitate constraining transverse movement of the retainer clip 256 and thus unwanted uncoupling of the retainer clip 256 from the AM valve housing 250. When desired, the retainer clip 256 is detached from the projection 274 and subsequently disengaged from outer tabs 270 to enable removal or insertion of the hydraulic valve assembly.

Described herein are systems and methods for an additive manufactured hydraulic valve body. Various features are formed in the additive manufactured valve body that otherwise could not be formed using conventional casting processes. The features include additive manufactured valve and accumulator housings integrated into the overall additive manufactured valve body and configured to have or receive retainer clips to retain valve or accumulator components within the housings. In this way, typically separate components are integrated into a single component, which drastically reduces the number of required fasteners and overall mass of the system.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An additive manufactured (AM) hydraulic control assembly comprising:
an AM housing having a tubular wall defining a bore configured to receive at least one of a hydraulic valve and an accumulator; and
a retainer clip configured to selectively secure to the AM housing such that the retainer clip is movable between a secured position that extends across at least a portion of the bore to retain the hydraulic valve or accumulator within the AM housing, and an unsecured position that enables the hydraulic valve or accumulator to be inserted into or removed from the bore.

2. The AM hydraulic control assembly of claim 1, further comprising an AM hydraulic passage having a second tubular wall defining a fluid passage, wherein the AM hydraulic passage is fluidly coupled to the bore.

3. The AM hydraulic control assembly of claim 2, wherein the at least one of a hydraulic valve and an accumulator comprises an accumulator having a plunger and a biasing mechanism.

4. The AM hydraulic control assembly of claim 1, wherein the AM housing includes a slot formed through the tubular wall, and
wherein the retainer clip includes an intermediate arm configured to be received within the slot when in the secured position.

5. The AM hydraulic control assembly of claim 4, wherein the intermediate arm is coupled to a main body between a pair of opposed arms configured to clip to the AM housing.

6. The AM hydraulic control assembly of claim 1, wherein the retainer clip is an AM retainer clip formed with the AM housing.

7. The AM hydraulic control assembly of claim 1, wherein the retainer clip includes a retainer body disposed between an attaching end configured to attach the retainer clip to the AM housing, and a securing end configured to selectively secure the retainer clip to the AM housing when in the secured position.

8. The AM hydraulic control assembly of claim 7, wherein the attaching end is hingedly coupled to the AM valve housing, and the securing end includes a detent configured to engage a projection formed on the AM valve housing when in the secured position.

9. The AM hydraulic control assembly of claim 8, wherein the attaching end includes a pair of knuckles additively manufactured with a clearance between the pair of knuckles and a pin formed on the AM housing.

10. The AM hydraulic control assembly of claim 8, wherein the attaching end includes a pin with opposed ends having detents formed therein, the detents configured to receive opposed projections extending from opposed support members integrally formed with the AM housing.

11. The AM hydraulic control assembly of claim 7, wherein the tubular wall includes an end face with at least one recess formed therein, and
wherein when in the secured position, the retainer clip is constrained within the recess from transverse movement to facilitate preventing detachment of the securing end from the AM housing.

12. The AM hydraulic control assembly of claim 7, wherein the at least one of a hydraulic valve and an accumulator comprises a hydraulic valve having a biasing mechanism and a valve coupled to a valve stem.

13. The AM hydraulic control assembly of claim 7, wherein the securing end is hook-shaped and configured to receive a tab integrally formed with and extending outwardly from the AM housing tubular wall.

14. The AM hydraulic control assembly of claim 7, wherein the securing end includes a transverse member defining opposed tabs configured to engage a pair of outer tabs integrally formed with and extending outwardly from the AM housing tubular wall.
